(19) United States
(12) Patent Application Publication
(10) Pub. No.: US 2002/0058434 A1
(43) Pub. Date: May 16, 2002

(54) PC card connector

(76) Inventors: Atsushi Nishio, Nishiibaraki-gun (JP); Souichi Takagi, Mito-shi (JP); Takashi Kawasaki, Hitachinaka-shi (JP)

Correspondence Address: Morrison Law Firm, 145 North Fifth Avenue, Mt Vernon, NY, 10550, US

(21) Appl. No.: 09/559,685

(22) Filed: Apr. 27, 2000

(30) Foreign Application Priority Data
Apr. 28, 1999 (JP) 11-122236

(51) Int. Cl. H01R 13/62

(52) U.S. Cl. 439/159

(57) ABSTRACT

In a PC card connector 10, a base 12 forms a PC card insertion section into which a PC card can be inserted. An arm 21 is pivotably supported in the region of the rear end of the base. An end 21a of the arm 21 is disposed in the PC card insertion section at one side of the PC card insertion section, and an other end 21b is projected sideways from the other side of the PC card insertion opening. An ejector member is disposed at the side edge of the other side of the PC card insertion section so that it can move forward and back. The other end of the arm engages with the ejector member. A projection 21c is formed on the arm 21. A shaft opening 12a is disposed on the base. The arm is interposed between a pushing section 12b and the base.

### BACKGROUND OF THE INVENTION

The present invention relates to a connector for PC cards such as memory cards.

Conventionally, the use of “PC cards” such as memory cards in electronic appliances has involved inserting the PC card into a PC card connector to connect it to the electronic appliance.

A PC card connector can, for example, be mounted in the electronic appliance so that the PC card insertion opening is open at a panel surface or the like of the electronic appliance. By inserting the PC card into a PC card insertion section through the PC card insertion opening, a connector section disposed at the rear end of the PC card is pushed into a slot on the main connector unit disposed at the back of the PC card insertion section. This provides an electrical connection between the PC card and the electronic appliance via the main connector unit.

In PC card connectors having this kind of structure, an ejection mechanism is provided to allow the PC card to be removed from the PC card insertion section of the PC card connector after the inserted PC card has been used.

This ejection mechanism can have the structure shown in FIG. 8 and FIG. 9, for example.

Referring to FIG. 8 and FIG. 9, an ejection mechanism 1 includes an arm 3 disposed at the back of the PC card insertion section, the arm being pivotably supported in the direction of PC insertion by a base 2 of the PC card connector.

The arm 3 is pivotably supported at a central part thereof by the base 2. When a PC card is inserted, an end 3a is pushed rearwards by the rear edge of the PC card. An other edge 3b engages with an ejection member (not shown in the figures) projecting from a panel surface of the like of the electronic appliance.

With the ejection mechanism 1 having the structure described above, when a PC card is inserted the end 3a of the arm 3 is pushed rearward by the back edge of the PC card, and the other end 3b is moved toward the front, thus moving the ejection mechanism forward. As a result, an eject button (not shown in the figure) disposed on the front end of the ejection member is projected prominently from the panel surface or the like.

When removing a PC card, the user pushes the eject button projecting from the panel surface or the like. The other end 3b of the arm 3 is pushed rearward, and the end 3a of the arm 3 is moved forward. As a result, the rear edge of the PC card is pushed forward by the end 3a of the arm 3, and the PC card is pushed forward from the PC card insertion section of the PC card connector. To remove the PC card, the user manually pulls out the PC card, which is partially projected.

Referring to FIG. 9, in the ejection mechanism 1 for PC card connectors described above, a projection 3c disposed at the center of the arm 3 is inserted into an attachment opening 2a disposed on the base 2. Then, the projection 3c is crimped so that the arm 3 is pivotably supported relative to the base 2.

Referring to FIG. 10 and FIG. 11, in an alternative structure the arm 3 uses an attachment member 4 to allow it to be pivotably supported to the base 2.

Thus, to mount the arm 3 to the base 2, crimping equipment or the attachment member 4 is required. This increases equipment costs and parts costs while also increasing assembly time, thus making assembly more costly.

### OBJECTS AND SUMMARY OF THE INVENTION

The object of the present invention is to overcome the problems described above and to provide an inexpensive PC card connector having an arm that can be easily mounted to a base.

In a PC card connector, a base forms a PC card insertion section into which a PC card can be inserted. An arm is pivotably supported in the region of the rear end of the base. An end of the arm is disposed in the PC card insertion section at one side of the PC card insertion section, and an other end is projected sideways from the other side of the PC card insertion opening. An ejector member is disposed at the side edge of the other side of the PC card insertion section so that it can move forward and back. The other end of the arm engages with the ejector member. A projection is formed on the arm. A shaft opening is disposed on the base. The arm is interposed between a pushing section and the base.

In the PC card connector according to the present invention, it would be desirable to have the pushing piece formed by cutting and bending up a section of the base.

In the PC card connector according to the present invention, it would be desirable to have the pushing piece disposed near the pivoting axis of the arm.

In the PC card connector according to the present invention, it would be desirable to have a projection disposed to restrict the end of the arm from pivoting toward the rear.

In the PC card connector according to the present invention, it would be desirable to have the projection formed by pressing a section of the base.

With the structure described above, the arm of the PC card connector is pivotably supported through an engagement between a projection or a shaft opening disposed thereon and a shaft opening or a projection disposed on the base as well as through interposing the arm between the base and a pushing piece formed integrally with the base.

Thus, the arm can be pivotably supported by the base without the need to perform crimping or to use an attachment member as in the conventional technology. This eliminates the need for crimping equipment and attachment members, thus reducing equipment and parts costs while allowing assembly to be performed easily, quickly, and at low cost.

If the pushing piece is formed by cutting and bending up a section of the base, the pushing piece is formed integrally with the base, thus eliminating the need to attach the pushing piece to a predetermined position on the base. This reduces parts costs and assembly costs.

If the pushing piece is disposed near the pivoting axis of the arm, the arm is pivotably supported relative to the base in a reliable manner. This prevents the arm from disengaging from the base during use.

If a projection is disposed to restrict the end of the arm from pivoting rearward, the end of the arm is prevented from being pushed more than necessary to the back when a PC card is being inserted into the PC card insertion section. This prevents damage to the main connector unit.

If the projection is formed by pressing a section of the base, the projection is formed integrally with the base. This eliminates the need to attach the projection to the base at a predetermined position and reduces parts costs and assembly costs.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a schematic perspective drawing showing an ejector mechanism according to an embodiment of the present invention mounted on a PC card connector.

FIG. 2 is a schematic plan drawing showing an ejector mechanism for the PC card connector of FIG. 1.

FIG. 3 (A) is a schematic perspective view of the ejector mechanism with the ejector member removed.

FIG. 3 (B) is a perspective view of the ejector mechanism as seen from below.

FIG. 4 (A) is an exploded perspective view of the base and arm of the ejector mechanism.

FIG. 4 (B) is an exploded perspective view of the same ejector mechanism but as seen from below.

FIGS. 5 (A)-5 (C) are perspective showings of the ejector mechanism showing the successive assembly step sequence involved in mounting the arm on the base in the ejector mechanism of FIG. 3.

FIG. 6 is a schematic perspective drawing showing a PC card inserted into the ejector mechanism of FIG. 2.

FIG. 7 is a schematic perspective drawing showing a PC card ejected from the ejector mechanism of FIG. 2.

FIG. 8 is a schematic perspective drawing showing the main elements from an example of a PC card connector according to the conventional technology.

FIG. 9 is an exploded perspective drawing of the ejector mechanism of FIG. 8.

FIG. 10 is a schematic perspective drawing showing the main elements from another example of a PC card connector according to the conventional technology.

FIG. 11 is an exploded perspective drawing of the ejector mechanism of FIG. 10.

### DETAILED DESCRIPTION OF THE PREFERRED EMBODIMENTS

Referring to the figures showing the embodiments, the following is a detailed description of the present invention.

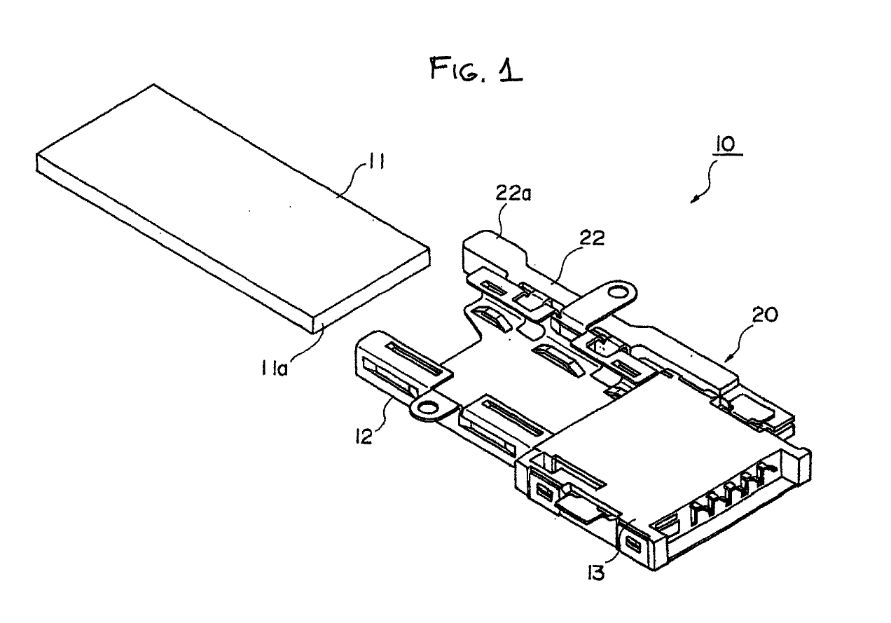

Referring to FIG. 1 through FIG. 7, there is shown the structure of a PC card connector equipped with an ejector mechanism according to an embodiment of the present invention.

Referring to FIG. 1, a PC card connector 10 includes: a base 12 forming a PC card insertion section into which a PC card 11 can be inserted toward a base rear end; a main connector unit 13 attached to the rear end of the base 12; and an ejector mechanism 20 disposed on the base 12.

Referring to FIG. 1, the base 12 is formed by bending a single sheet of metal.

The main connector unit 13 is attached to the rear end of the base 12 and is formed with a slot (not shown in the figure) into which is inserted a connecting section (not shown in the figure) disposed at the rear end 11a of the PC card 11.

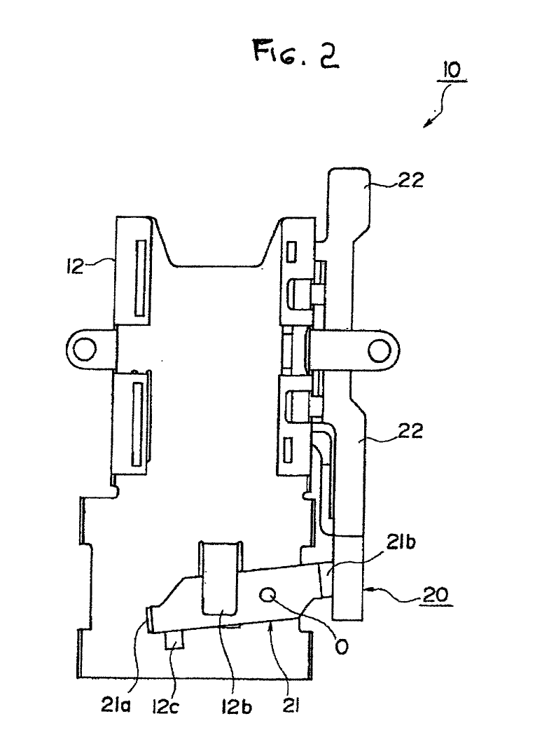

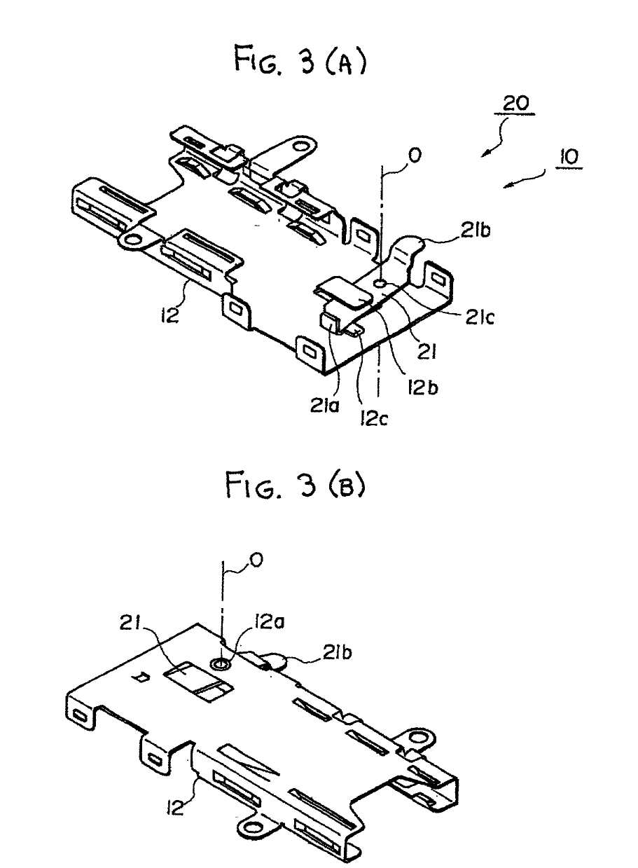

Referring to FIG. 2 and FIG. 3, the ejector mechanism 20 includes: an arm 21 disposed in the region of the rear end of the base 12; and an ejector member 22 disposed along the side edge (the right side in FIG. 2) of the base 12.

The arm 21 is disposed in the region of the rear end of the base 12 and is pivotably supported around a rotation axis O perpendicular to the lateral axis and the direction of insertion of the PC card 11.

All end 21a (the left end of FIG. 2) of the arm 21 is disposed inside the PC card insertion section at one side of the PC card insertion section. An other end 21b is projected to the side from the other side of the PC card insertion section.

In the figure, the end 21a of the arm 21 is bent perpendicular and engages with the rear end of the PC card 11.

The ejector member 22 is supported at the edge of the other side of the PC card insertion section of the base 12 by a mechanism not shown in the figure so that it can move forward and back. An engagement opening (not shown in the figure) is disposed on the ejector member 22 to engage with the other end 21b of the arm 21.

Furthermore, a front end 22a of the ejector member 22 is projected toward the front. When the PC card connector 10 is mounted in an electronic appliance or the like, the front end 22a serves as an eject button and projects from a panel surface of the electronic appliance or the like.

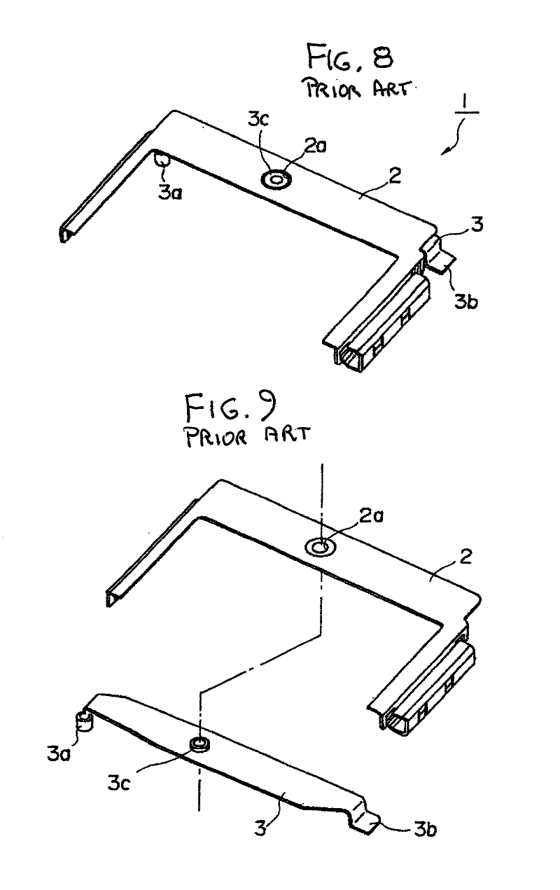

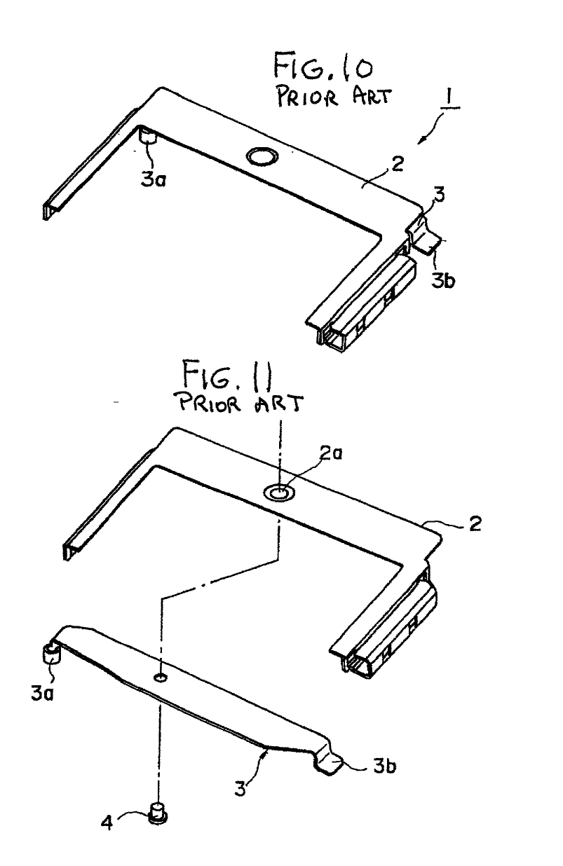

The structure described above is similar to the conventional ejector mechanism shown in FIG. 8 and FIG. 10, but the ejector mechanism 20 according to the present invention differs in the following manner.

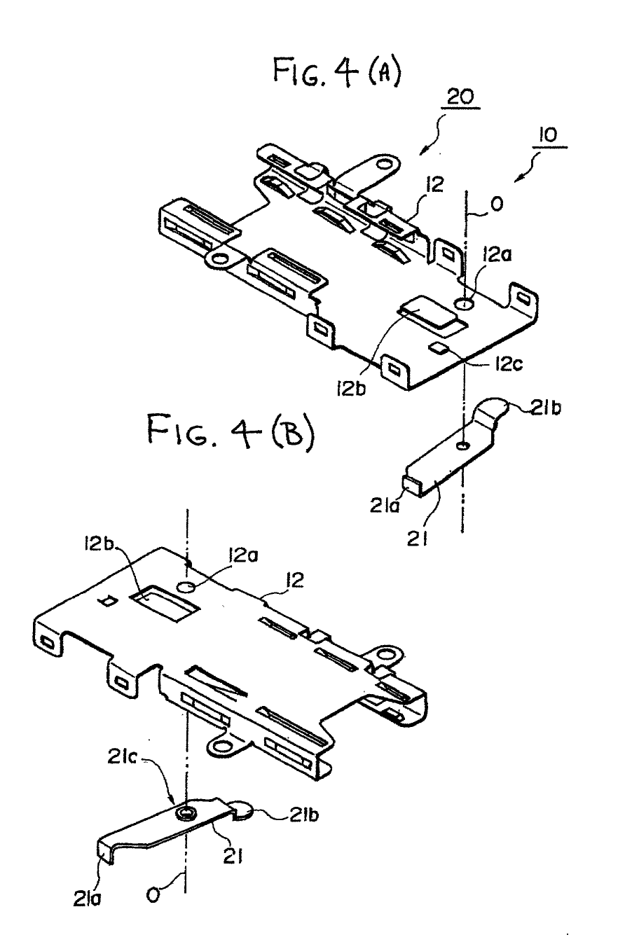

Referring to FIG. 4, in the ejector mechanism 20, a projection 21c formed on the arm 21 at the position of the rotation axis O is fitted in an shaft opening 12a disposed on the base 12 at the position of the rotation axis O. The arm 21 is interposed between the base 12 and a pushing piece 12b formed on the base 12, thus pivotably supporting the arm 21 relative to the base 12.

The pushing piece 12b is formed integrally with the base 12 by stamping a section of the base 12 or the like.

In the ejector mechanism 20, a stop projection 12c is formed on the base 12 to serve as a stopper that restricts rearward movement of the end 21a of the arm 21.

This projection 12c is formed as a part pressed out from the structure of the base 12.

Thus, the pushing piece 12b and the projection 12c can be formed easily by pressing.

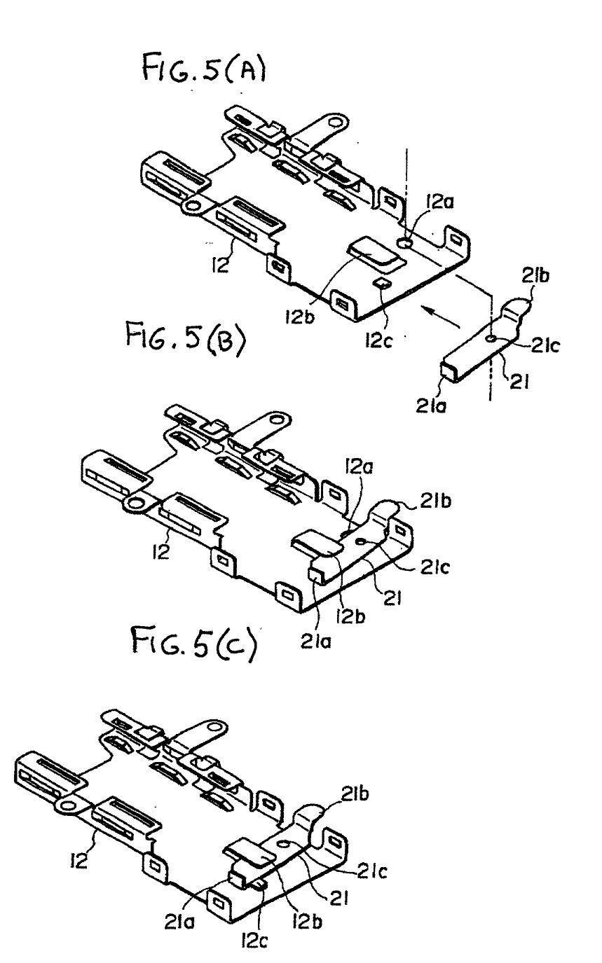

Referring to FIG. 5, the ejector mechanism 20 of the PC card connector 10 according to this embodiment of the present invention allows the arm 21 to be mounted to the base 12 in the following manner.

Referring to FIG. 5(A), the arm 21 is slid along the base 12 and inserted from the rear between the pushing piece 12b and the base 12 (see FIG. 5(B)).

Referring to FIG. 5(C), the projection 21c of the arm 21 is fitted into the shaft opening 12a of the base 12.

In this manner, no crimping equipment or attachment member is required and the arm 21 can be attached to the base easily and quickly.

With the ejector mechanism 20 assembled in this way, the PC card 11 can be inserted into the PC card insertion section of the PC card connector 10. Referring to FIG. 6, the rear end 11a of the PC card 11 will then push the end 21a of the arm 21 toward the rear. This will cause the arm 21 to rotate around the pivot axis formed by the projection 21c . The other end 21b will move toward the front, and this will cause the ejector member 22 to move to the front. As a result, the ejector button 22a at the front end of the ejector member 22 will project from the panel surface or the like of the electronic appliance in which the PC card connector 10 is mounted.

In this case, the rotation of the arm 21 is restricted by the abutment of the end 21a against the projection 12c , thus preventing the PC card 11 from being pushed in inappropriately. This prevents the connection section of the main connector unit 13 and the PC card 11 from being damaged.

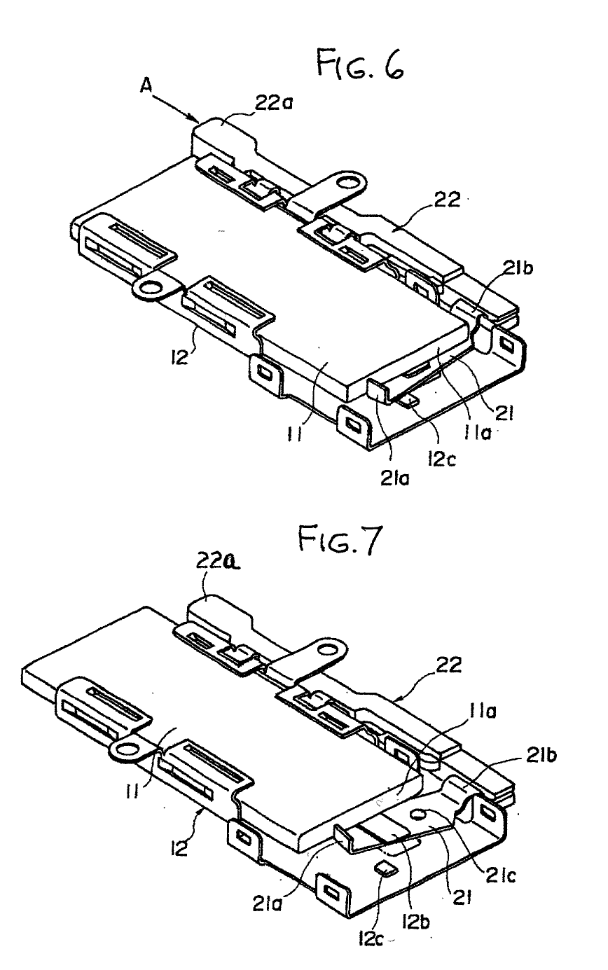

Referring to FIG. 6, the PC card 11 is removed by pushing the ejector button 22a in the direction indicated by the arrow A. Referring to FIG. 7, the ejector member 22 moves toward the back, causing the other end 21b of the arm 21 to move to the back. This causes the arm 21 to rotate around the pivot axis O formed by the projection 21c , with the end 21a moving forward so that the rear end 11a of the PC card 11 is pushed forward by the end 21a of the arm 21.

The user then grasps a part of the PC card projecting from the PC card insertion section of the PC card connector 10, thus allowing the PC card to be removed.

In this embodiment, the pivot axis for the arm 21 is formed by having a projection 21c disposed on the arm 21 and having a shaft opening 12a formed on the base 12. However, the present invention is not restricted to this structure, and it would of course be possible to have the shaft opening formed on the arm 21 and the projection formed on the base 12.

As described above, in the present invention the shaft opening or the projection disposed on the arm of the ejector mechanism engages with the projection or the shaft opening disposed on the base and is interposed between the base and the pushing piece formed integrally with the base, thus allowing the arm to be pivotably supported.

Thus, the arm can be pivotably supported relative to the base without the need for a crimping operation or an attachment member as in the conventional technology. Since crimping equipment and attachment members are not required, the equipment costs and parts costs are reduced while assembly can be performed more quickly. This shortens assembly time and reduces assembly costs.

When the pushing piece is formed by bending up a section of the base, the pushing piece is formed integrally with the base so there is no need to attach the pushing piece -to a predetermined position on the base. This reduces parts costs and assembly costs.

Thus, with the present invention, the arm can be mounted easily to the base so that a superior PC card connector can be provided at a reduced cost.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. In a PC card connector including: a base forming a PC card insertion section into which a PC card can be inserted toward a base rear end; an arm mounted to the base for pivoting about an axis perpendicular to a direction of insertion of said PC card into said insertion section and to an axis extending laterally of said PC card, said arm having one end thereof disposed in said PC card insertion section at one side of said PC card insertion section, another opposite end of said arm being extended sideways from another opposite side of said PC card insertion section; and an ejector member disposed at an edge of said another opposite side of said PC card insertion section, said ejector member being movable toward and away from the base rear end, said ejector member being engagable with said another opposite end of said arm;
the PC card connector further comprising:
a pivot projection positioned at said pivoting axis of said arm and carried on one of said arm and said base;
a shaft opening disposed positioned at said pivoting axis of said arm and being in one of said base and said arm; and
a pushing piece formed integrally with said base, said arm being interposed between said pushing piece and said base.

2. A PC card connector as described in claim 1 wherein said pushing piece is a cut and bent up section of said base.

3. A PC card connector as described in claim 1 wherein said pushing piece is disposed proximal said pivoting axis of said arm.

4. A PC card connector as described in claim 1 further comprising a stop projection carried on said base for restricting pivoting movement of said one end of said arm in a rearward direction.

5. A PC card connector as described in claim 4 wherein said stop projection is formed as a part pressed out from the structure of said base.
